(19) United States
(12) Patent Application Publication
(10) Pub. No.: US 2014/0357188 A1
(43) Pub. Date: Dec. 4, 2014

(54) INTERACTIVE ACCESSORIES

(71) Applicant: Zydeco Entertainment, LLC, Riverwoods, IL (US)

(72) Inventor: Ilyse R. Brainin, Glenview, IL (US)

(21) Appl. No.: 14/368,425

(22) PCT Filed: Jan. 14, 2013
(86) PCT No.: PCT/US2013/021447

§ 371 Date: Jun. 24, 2014

Related U.S. Application Data
(60) Provisional application No. 61/586,557, filed on Jan. 13, 2012.

(51) Int. Cl. H04B 5/00; H04B 1/38

(52) U.S. Cl. CPC H04B 5/0031; H04B 1/385
USPC 455/41.1

(57) ABSTRACT

A device for securing a decorative accessory with an interactive device, such as a NFC tag, to a person and/or a personal item and a method of using the device to participate in an online activity including an online game, a rewards program and/or a social media platform.

### BACKGROUND OF THE INVENTION

1. Field of the Invention

This invention relates generally to a decorative accessory having an interactive device, such as a near field communication tag, and securing such device to a person, such as finger, wrist and neck, and/or a personal item, such as shoes, flip flops, bags and writing instruments. This invention further relates to a method of using the device to participate in an online activity including a game, a rewards program and/or a social media platform.

2. Discussion of Related Art

People often have a desire to express themselves by adorning accessories to themselves or to personal items that show characters, objects, colors, and representations they are attracted to. The challenge is to find a system and method that is functional across many accessory types, is safe, holds securely around a given object, is easily removable, and is desirable to wear.

Recently there has been a growing interest in interactive schemes for participating in online activities and for recognizing attendance at various venues including restaurants, amusement parks, stores, concert venues and charity events. These online activities may include online games, online rewards programs, online charity drives, social media registration, and registration for priority privileges at an event or website. Currently, known interactive devices for participation in online activities are in the form of smart phones, and/or scannable cards or key ring tags. However, these known interactive devices do not provide a fun and fashionable way to display a person's participation in the online activity. Furthermore, these known interactive devices are generally not readily accessible for registering visits to a place or event.

Accordingly, there is a need for a system that can be used to adorn accessories to oneself or one's personal items while also providing a simple or even passive means of registering visits to a place or event and participating in an online activity.

### SUMMARY OF THE INVENTION

A general object of the invention is to provide a system for attaching a decorative accessory with an interactive tag to a wearer's body and/or personal possessions in order to facilitate participation in an online activity.

In one embodiment of this invention, the system for attaching the decorative accessory includes a decorative accessory and a tether. In a preferred embodiment, the decorative accessory comprises a charm mounted to a base and a shaft extending from the base. The decorative accessory allows a wearer to express himself or herself by displaying an interest, for example, but not limited to, a character, a sports team, a game logo, color, a design and/or a statement.

In an embodiment of this invention, the tether comprises a band that can be wrapped and secured around the wearer's body, for example a finger, wrist, neck and head, or around a personal item, for example, flip flops, shoes, backpacks, glasses, bracelets and writing instruments. The tether further comprises a hole in the band for attaching the decorative accessory and a fastener for securing a first portion of the band to a second portion of the band. In a preferred embodiment, the hole comprises an expandable cats-eye hole and the fastener comprises a hook and loop fastener. Alternatively, the hole can be of any shape and the fastener may comprise any type of fastener known to one of ordinary skill in the art.

In an embodiment of this invention, the decorative accessory comprises the charm mounted to the base with a permanent connection, for example a molded or adhesive connection. A shaft extends from the base and comprises a relatively narrow diameter near the base that expands to a wider diameter at a position opposite to the base. The decorative accessory is removably connected to the tether by passing the wider diameter of the shaft through the expandable cats-eye hole in the tether. Once pressed through, the expandable cats-eye hole returns to its un-stretched state around the relatively narrow diameter of the shaft and with the base on one side of the tether and the wider diameter portion of the shaft on the other side of the tether thereby securing the decorative accessory to the tether.

In a preferred embodiment of this invention, the decorative accessory further includes an interactive tag that is capable of being read by an interactive tag reader. The interactive tag reader is preferably connected to an online program for participation in an online activity such as, but not limited to, an online game, a rewards program, a social media website and a marketing program. For example, in the rewards program, a participant can use the decorative accessory of this invention to check into stores and other locations by bringing the interactive tag in proximity to the interactive tag reader at the location in order to gain rewards points that can be redeemed in an application based rewards system. In another example, the interactive tag can be used as a token for a scavenger hunt based game. For instance, an amusement park or other similar venue may set up the scavenger hunt game as a way to encourage visitors to explore the park. The amusement park may further set up various scavenger hunts directed to particular types of customers, for example, young children, teens, adults and fans of a particular movie or book. As a participant finds an item on the scavenger hunt list, for example a ride, a restaurant, a costumed character, a region of the park, the participant can scan their interactive tag with an interactive tag reader positioned near the located item to register the find with an online system. The amusement park may then chose to reward participants with gifts, gift cards, money, and/or special park privileges such as VIP access to rides and other activities.

In a preferred embodiment, the interactive tag and interactive tag reader is a Near Field Communications (NFC) based system. In alternative embodiments, the interactive tag may comprise another system including but not limited to, radio-frequency identification (RFID), Bluetooth, and magnetic encoding.

### BRIEF DESCRIPTION OF THE DRAWINGS

These and other objects and features of this invention will be better understood from the following detailed description taken in conjunction with the drawings, wherein:

FIG. 1 is an interactive accessory according to one embodiment of this invention.

FIG. 2 is an exploded view of the interactive accessory of FIG. 1.

FIG. 3 is the interactive accessory of FIG. 1 connected in a loop.

FIG. 4 is a pair of interactive accessories worn as a bracelet according to an embodiment of this invention.

FIG. 5 is the interactive accessory of FIG. 1 worn as a ring.

FIG. 6 is the interactive accessory of FIG. 1 connected to a writing instrument.

FIG. 7 is a plurality of interactive accessories linked together according to an embodiment of this invention.

FIG. 8 is the interactive accessory of FIG. 1 shown interacting with a plurality of devices.

FIG. 9 is the interactive accessory of FIG. 1 shown interacting with a reader/writer data converter.

### DETAILED DESCRIPTION OF THE INVENTION

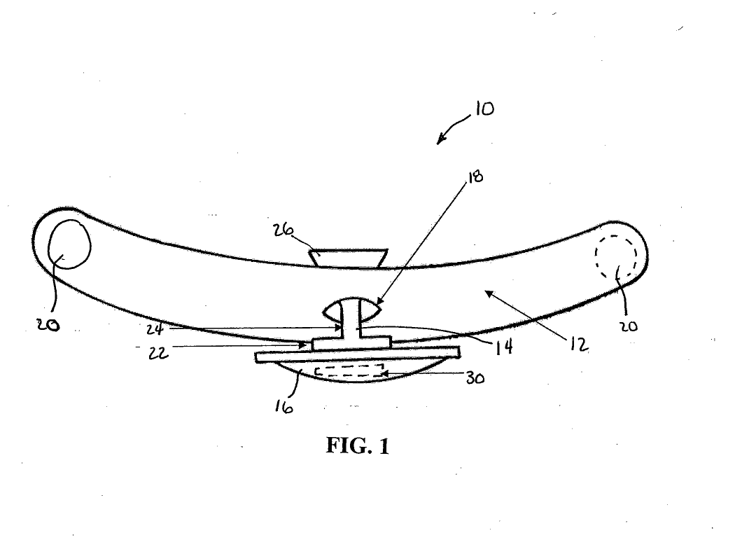

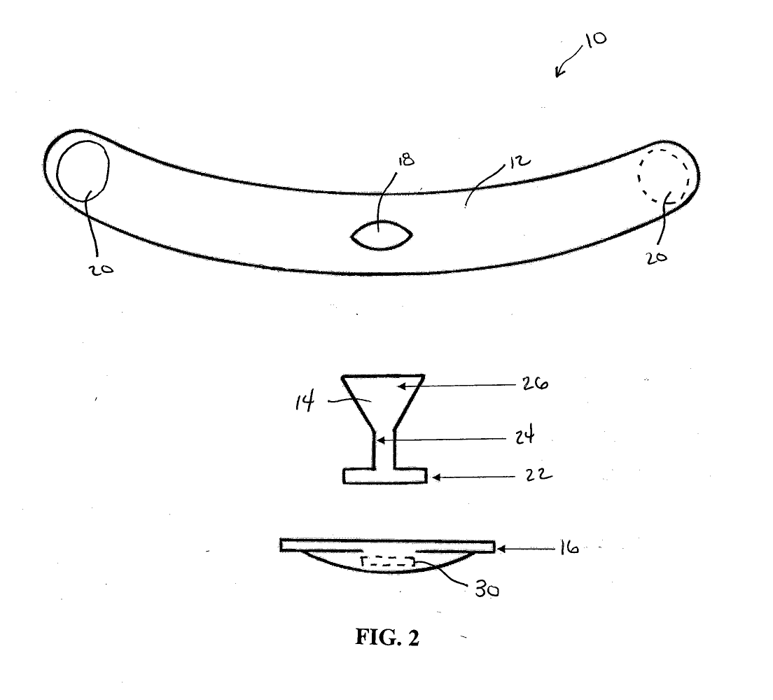

FIG. 1 shows a preferred embodiment of a device 10 for attaching a decorative accessory with an interactive tag to a wearer's body and/or personal possessions to enable participation in an online activity. FIG. 2 shows an exploded view of the device shown in FIG. 1. As shown in FIGS. 1 and 2, the device 10 preferably includes a tether 12, a connector 14 and a decorative accessory 16.

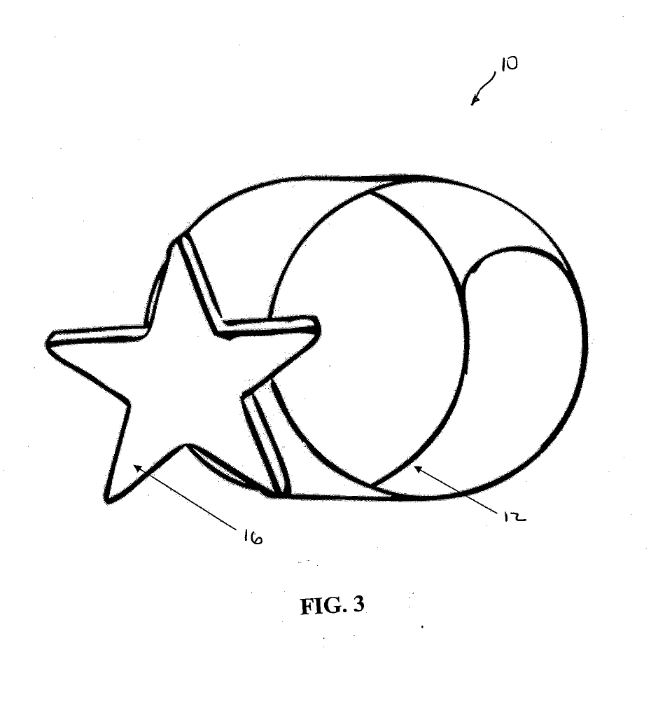

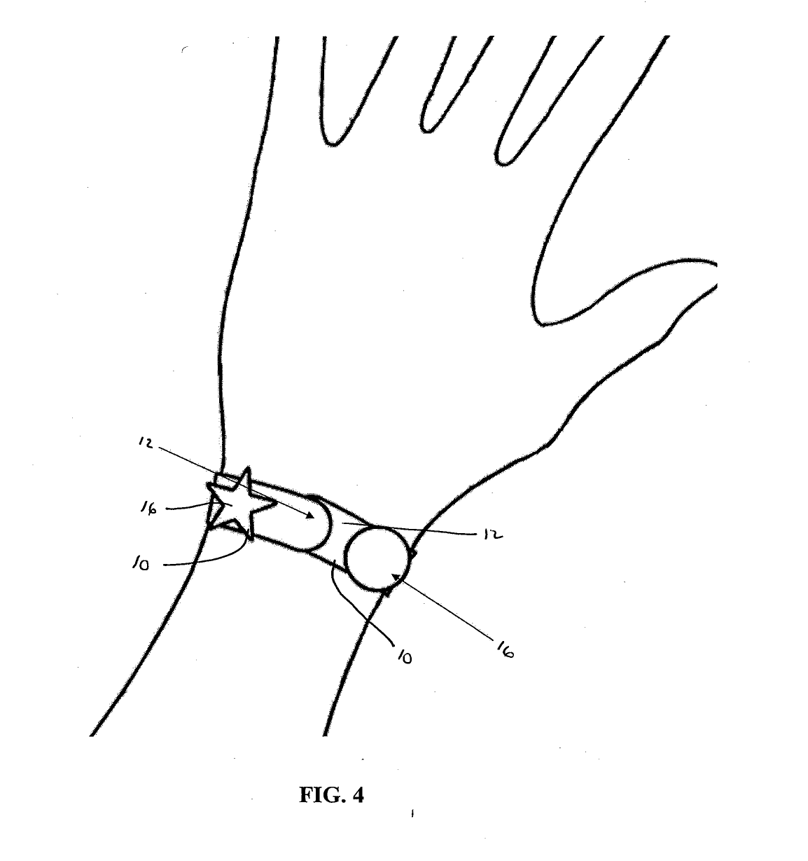

The tether 12 preferably comprises a flexible and durable material with a hole 18 for the connector 14 pass through and a fastener 20 for creating a loop or connecting the tether 12 to another tether. In this embodiment, the tether 12 is constructed from nylon however, the tether 12 is not limited to nylon and may be manufactured from any type of material including but not limited to cloth, rubber and leather. In an embodiment, the hole 18 comprises an expandable cats-eye shaped hole that is capable of stretching to accommodate at least a portion of the connector 14 to secure the decorative accessory 16 to the tether 12. Alternatively, the hole 18 may comprise any shape, such as a slot or a circle, in order to secure the decorative accessory 16 to the tether 12 as described below. In an embodiment, the fastener 20 comprises a pair of fasteners 20 positioned on either end and opposite sides of the tether 12 to allow the tether 12 to be attached to itself in a loop, as shown in FIG. 3. Alternatively, the fasteners 20 can be used to link two or more tethers 12 together in a chain, such as shown in FIGS. 4 & 7. In an alternative embodiment, the fastener 20 may not only be positioned on the ends of the tether 12 but may be positioned anywhere on the tether 12. In a preferred embodiment, the fastener 20 comprises a hook and loop fastener. However, the fastener 20 is not limited to the hook and loop fastener and may comprise any type of fastener including, but not limited to, a snap connection, a button and clasp.

As best shown in FIG. 2, the connector 14 comprises a base 22, a shaft 24 and a tapered end 26. In a preferred embodiment, the connector 14 is made of a durable material such as plastic, metal or a composite material. The base 22 is preferably permanently attached to the decorative accessory 16. The permanent attachment may be formed with an adhesive connection, a weld connection or by integrally forming the connector 14 to the decorative accessory 16. In an alternative embodiment, the base 22 may be connected to the decorative accessory with a releasable connection that allows the decorative accessory 16 to be changed for another decorative accessory. The shaft 24 extends from the base 22 and connects to the tapered end 26 at a narrow portion of the tapered end 26. The tapered end 26 expands to a wide end opposite the shaft 24. In this embodiment, the tapered end 26 gradually tapers from the narrow portion to the wide end in a cone shape, however, the tapered end 26 need not comprise a gradual taper and may comprise an abrupt taper, similar to the transition from the base 22 to the shaft 24.

In the embodiment of FIGS. 1 and 2, the decorative accessory 16 comprises a circular dome shaped charm. However, the decorative accessory 16 is not limited to this shape and may comprise any shape or design including, but not limited to, a team logo, a comic book hero, a movie character, a zodiac sign, a political statement, a company logo, a video game symbol, a mood ring, an identifier of a cause, an animal shape or another design.

In a preferred embodiment, the wide end of the tapered end 26 of the connector 14 is sized to be approximately equal to or slightly smaller than the hole 18 in the tether 12. In operation, the wide end of the tapered end 26 is pressed through the hole 18 in the tether 12 so that the tapered end 26 of the connector 14 is on one side of the tether 12 and the base 22 and the decorative accessory 16 is on the other side of the tether 12, such as shown in FIG. 1. This button-like connection provides a secure connection that permits easy swapping of decorative accessories.

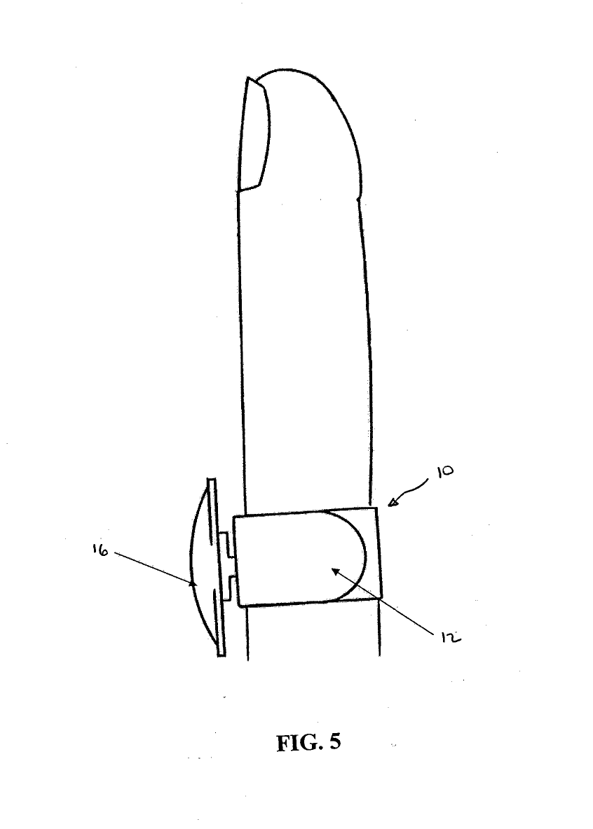

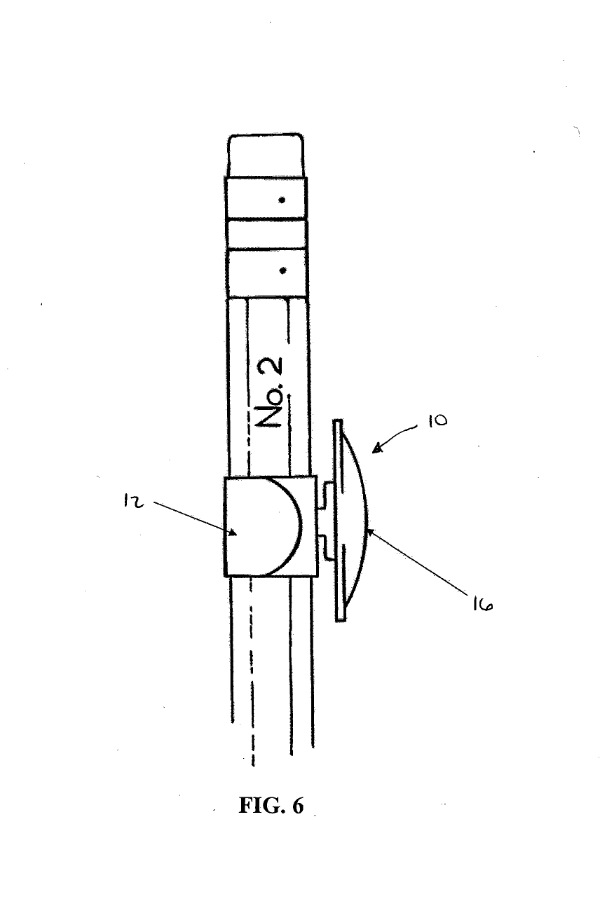

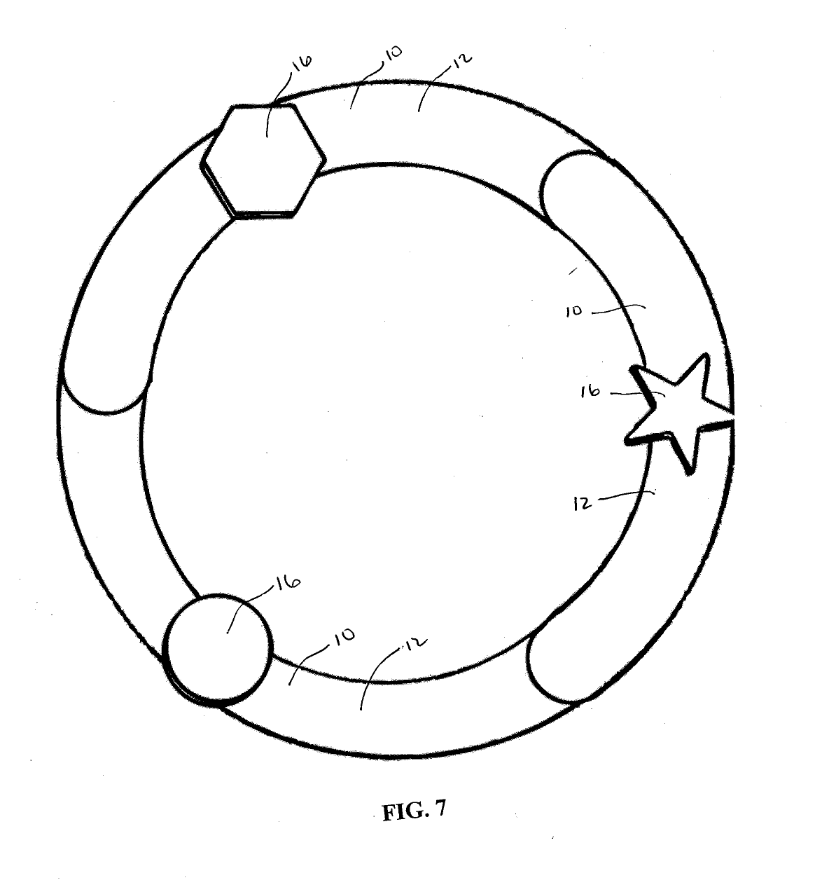

The device 10 described above provides a versatile system for attaching the device 10 to the wearer's body or personal items. For example, FIG. 3 shows an embodiment of the device 10 with the tether 12 connected to itself in a loop by connecting the two fasteners 20 to each other, allowing the device to be attached to a variety of items, including, but not limited to, shoes, flip flops, backpacks, bracelets, necklaces, writing instruments, eyeglasses and wrist bands. The embodiment of FIG. 3 may also be used to secure the device 10 to the wearer's body, such as on fingers, wrists, neck, head and/or ankles. FIG. 4 shows a pair of devices 10 joined to each other to form a bracelet. FIG. 5 shows an embodiment of this invention used as a ring. FIG. 6 shows an embodiment of this invention connected to a writing instrument. FIG. 7 shows a plurality of devices 10 joined in a serial connection, allowing for the plurality of device to be worn as a necklace or a headband.

In a preferred embodiment of this invention, the device 10 further includes an interactive tag 30 positioned on or within the decorative accessory 16 that allows the device to register real world activities by scanning the interactive tag 30 at interactive tag readers 32 and track the real world activities with an online program. For example:

1. Activating points, powers, achievements, and/or themed characters as part of an online or mobile game experience.

2. Accumulating points as a part of a retail rewards program by visiting or purchasing products at a store.

3. Raising funds or other benefits for a cause related marketing program for a charity, for example a charity walk-a-thon.

4. Registering visits in conjunction with a social media platform, such as registering visits to a restaurant, bar, concert, or sporting event.

5. Activating or accessing an embedded or restricted access website.

6. Redeeming an embedded code for a particular offer.

7. Activating an embedded code to enter into a sweepstakes or to redeem an instant winner.

8. Creating collectable charms that can be individually serialized through the NFC tag.

9. A method for prioritizing attendees to an attraction, concert, or other event by using a serialized number embedded into the NFC tag code.

10. Tracking locations for a scavenger hunt type game.

11. A ticketing program providing access to a special event, show or activity, such as sports tickets, concert tickets, ski lift tickets, and access tickets.

12. A restaurant reservation system.

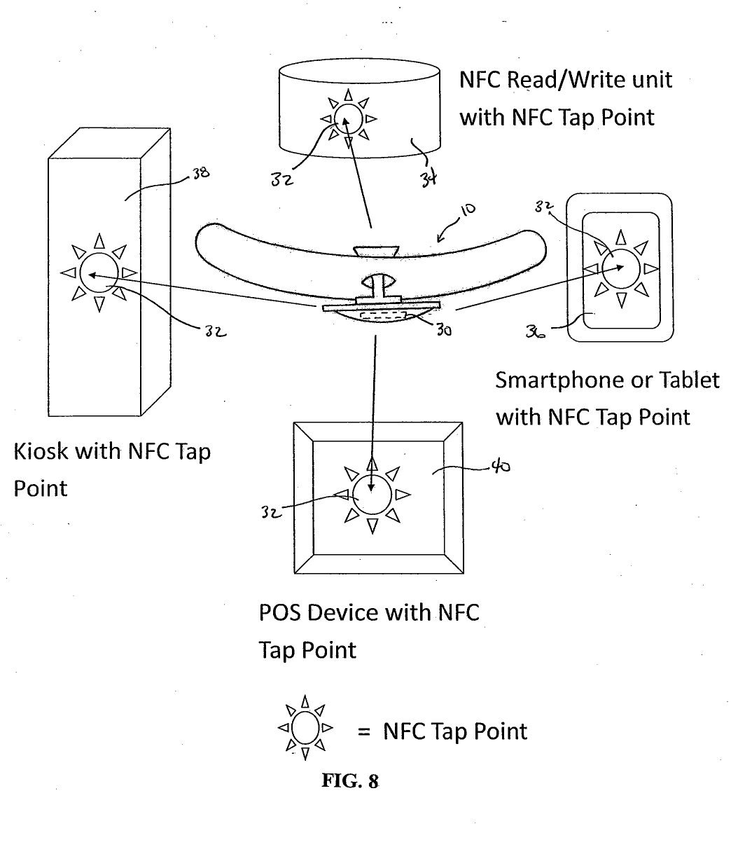

In a preferred embodiment of this invention, the interactive tag 30 is a Near Field Communication (NFC) tag with special code or data that interacts with NFC tap points 32 on various types of devices. For example as shown in FIG. 8, a proprietary NFC tag reader 34, an NFC enabled mobile phone or tablet 36, a kiosk with an NFC tag reader 38, and a point of sale device 40. Alternatively, the interactive tag 30 and the interactive tag reader 32 may comprise any type of interactive tag reader system such as, but not limited to, a radio-frequency identification (RFID) system, a Bluetooth system, and a magnetic encoded system. However, the NFC system is preferred for its proven, transparent, secure and fast system for transferring data. The data transfer system can be asynchronous as well as synchronous and does not need to be connected to a cellular or Wi-Fi network in order to engage. Further, the NFC system is a low-power system that does not need to be paired, and can transfer data in a fraction of a second.

The process of using the device 10 of this invention begins by programming the NFC tag 30. The NFC tag 30 may be pre-programmed or programmed after being installed in the decorative accessory 16. The programming preferably includes associating the NFC tag 30 with a unique identifier. The unique identifier allows a back end system to track the NFC tag 30 to a geo-spatial location, an inception date, a frequency of use, and pre-determined sequences. In a preferred embodiment, the NFC tag 30 is programmed with a cryptogram that allows for secure confirmation that the NFC tag 30 is an authenticated and authorized component with rights to access an online application. The wearer of the device 10 brings the NFC tag 30 to various NFC readers 32 in order to register visits, achieve rewards and/or collect credits or points for the associated online activity. The system of this invention automatically exchanges information when the NFC tag 30 is brought in proximity to the NFC tap point 32, usually less than 4 centimeters away from each other.

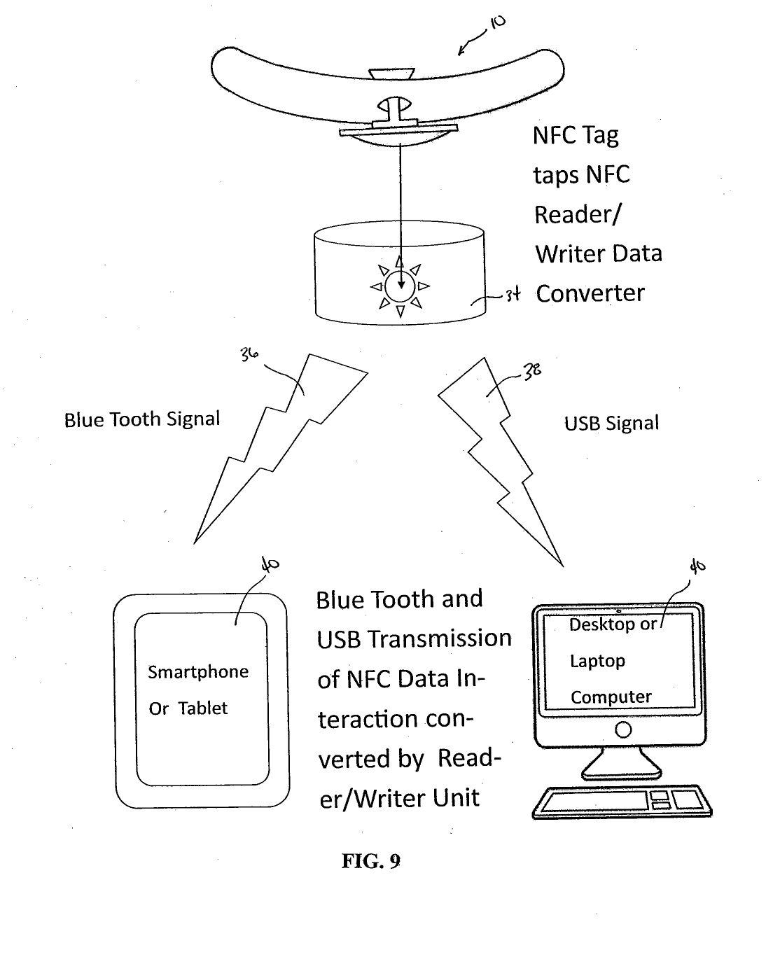

In an embodiment of this invention, shown in FIG. 9, the NFC based system of this invention can be expanded to allow for interaction with non-NFC based systems with a NFC reader/writer data converter 34 that converts the NFC data into data compliant with another system, for example a Bluetooth system 36 or a USB transmission system 38.

Thus, the invention provides a device for securing a decorative accessory with an interactive device, such as a NFC tag, to a person and/or a personal item and a method of using the device to participate in an online activity including an online game, a rewards program and social media platform.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

What is claimed is:

1. An interactive device comprising:
a tether including a hole and a fastener for attaching the interactive device to a person or personal item;
a decorative accessory mounted to a connector, the connector comprising a base, a shaft and a tapered end, wherein the base is connected to the decorative accessory and the connector is releasably attached to the tether by passing a wide part of the tapered end through the hole in the tether; and
an interactive tag connected to the decorative accessory.

2. The interactive device of claim 1, wherein the interactive tag comprises a near field communication tag.

3. The interactive device of claim 2, further comprising:
a near field communication tag reader connected to an online activity, the near field communication tag reader identifying the near field communication tag when the near field communication tag is brought in proximity to the near field communication tag reader.

4. The interactive device of claim 3, wherein the online activity comprises one of a retail rewards based program, a scavenger hunt game, an online game, a charity collection drive program, a social media platform, a limited access website, a sweepstakes program, a VIP priority program and a ticketing program.

5. The interactive device of claim 3, further comprising:
a near field communication reader/writer data converter, the near field communication reader/writer data converter capable of identifying the near field communication tag when the near field communication tag is brought in proximity to the near field communication reader/writer data converter and transmitting a non-NFC based signal to non-NFC capable external devices.

6. The interactive device of claim 1, wherein the interactive tag is programmed with a unique identifier.

7. The interactive device of claim 1, wherein the decorative accessory comprises one of a team logo, a symbol, a comic book hero, a movie character, a cartoon character, a zodiac sign, a political statement, a company logo, and a video game symbol.

8. The interactive device of claim 1, wherein the tether can be formed in a loop to connect the interactive device to one of a finger, a wrist, a neck, a head, an ankle, a shoe, a flip flop, a bag, a writing instrument, a bracelet, a necklace, an eyeglass, a clothing loop, and a wrist band.

9. The interactive device of claim 1, wherein a plurality of tethers can be joined to create a linked chain of the tethers.

10. A method of using an interactive device with an online activity comprising:
providing a decorative accessory with a near field communication tag;
programming the near field communication tag to be associated with a unique identifier;
positioning the near field communication tag in proximity to a near field communication tag reader; and
transmitting data of the near field communication tag from the near field communication tag reader to an online program associated with the online activity.

11. The method of claim 10, further comprising:
programming the near field communication tag with a cryptogram for secure confirmation that the near field communication tag is authentic.

12. The method of claim 10, further comprising:
tracking at least one of a geo-spatial location, an inception date, a frequency of use and a sequence of the near field communication tag.

13. The method of claim 10, wherein the online activity comprises one of a retail rewards based program, a scavenger hunt game, an online game, a charity collection drive program, a social media platform, a limited access website, a sweepstakes program, a VIP priority program and a ticketing program.

14. The method of claim 10, further comprising:
converting a near field communication data transfer to a non-NFC based signal for transmission of data to non-NFC capable external devices.

15. The method of claim 10, further comprising:
connecting the decorative accessory with the near field communication tag to a tether;

16. The method of claim 15, further comprising:
attaching the tether to one of a finger, a wrist, a neck, a head, an ankle, a shoe, a flip flop, a bag, a writing instrument, a bracelet, a necklace, an eyeglass, a clothing loop, and a wrist band.

17. A method of using an interactive device with an online activity comprising:
providing a decorative accessory with a near field communication tag;
programming the near field communication tag to be associated with a unique identifier;
searching for a scavenger hunt item with a near field communication tag reader;
positioning the near field communication tag in proximity to the near field communication tag reader to register the scavenger hunt item; and
transmitting data of the near field communication tag from the near field communication tag reader to an online program associated with the online activity.

18. The method of claim 17, further comprising:
programming the near field communication tag with a cryptogram for secure confirmation that the near field communication tag is authentic.

19. The method of claim 17, further comprising:
converting a near field communication data transfer to a non-NFC based signal for transmission of data to non-NFC capable external devices.

20. The method of claim 17, further comprising:
connecting the decorative accessory with the near field communication tag to a tether and attaching the tether to one of a finger, a wrist, a neck, a head, an ankle, a shoe, a flip flop, a bag, a writing instrument, a bracelet, a necklace, an eyeglass, a clothing loop, and a wrist band.
